(19) United States
(12) Patent Application Publication
(10) Pub. No.: US 2013/0088222 A1
(43) Pub. Date: Apr. 11, 2013

(54) SYSTEM AND METHOD FOR MEASURING WRINKLE DEPTH IN A COMPOSITE STRUCTURE

(71) Applicant: Jeffrey P. Nissen, Fort Worth, TX (US)

(72) Inventor: Jeffrey P. Nissen, Fort Worth, TX (US)

(73) Assignee: BELL HELICOPTER TEXTRON INC., FORT WORTH, TX (US)

(21) Appl. No.: 13/699,777

(22) PCT Filed: May 10, 2011
(86) PCT No.: PCT/US2011/035818

§ 371 Date: Nov. 26, 2012

(51) Int. Cl. G01N 27/90

(52) U.S. Cl. CPC G01N 27/9013
USPC 324/240

(57) ABSTRACT

In accordance with one embodiment, a method is provided for non-destructive examination of a composite structure having a non-conductive surface and a conductive substrate. The method may include applying an alternating current to a probe having a coil conductor, scanning the probe across the non-conductive surface to induce eddy currents in the conductive substrate, and measuring changes in an electrical property of the probe in response to changes in the eddy currents indicative of variations in the depth of the conductive substrate.

### TECHNICAL FIELD

This disclosure relates in general to the field of composite structures, and more particularly to a system and method for measuring wrinkle depth in a composite structure.

### DESCRIPTION OF THE PRIOR ART

Many modern structures feature composite materials in lieu of traditional materials, such as aluminum. Composite materials are generally lighter than aluminum, and can also provide better mechanical and fatigue properties than aluminum. However, composite materials can also be much less electrically conductive than aluminum, which can present significant problems for structures that are vulnerable to lightning strikes, such as aircraft and wind turbines.

While traditional aluminum structures can direct lightning strikes around internal electronic components, fuel tanks, and passengers, composite materials do not readily conduct away these extreme electrical currents. Without an adequate conductive path, lightning may cause arcing and hot spots, which can have severe consequences.

Conductive lightning strike protection (LSP) systems can be used to provide a conductive path for composite materials in such applications. In general, LSPs seek to provide adequate conductive paths so that lightning remains on the exterior of a structure. LSPs can also provide grounding, EMF shielding, and surge suppression to protect wiring, cables, and other equipment.

Imperfections in the composite material, such as wrinkles, can interfere with LSPs and adversely affect the strength of the material. For example, an aircraft may have a non-conductive paint or resin applied over an LSP system, but the LSP system can be rendered ineffective if wrinkles in the LSP cause the non-conductive surface material to be too deep. Detecting such imperfections, however, continues to present significant challenges to engineers and manufacturers.

### BRIEF DESCRIPTION OF THE DRAWINGS

The features believed characteristic and novel of the system and method described herein are set forth in the appended claims. However, the system, as well as a preferred mode of use, and further objectives and advantages thereof, will best be understood by reference to the following detailed description when read in conjunction with the accompanying drawings, wherein:

FIG. 1 is a simplified schematic diagram of an example embodiment of a system for determining surface wrinkle depth in a composite specimen, in accordance with this specification.

While the system is susceptible to various modifications and alternative forms, novel features thereof are shown and described below through specific example embodiments. It should be understood, however, that the description herein of specific example embodiments is not intended to limit the system or apparatus to the particular forms disclosed, but on the contrary, the intention is to cover all modifications, equivalents, and alternatives falling within the spirit and scope of the appended claims.

### DESCRIPTION OF THE PREFERRED EMBODIMENT

Illustrative embodiments of the novel system are described below. In the interest of clarity, not all features of such embodiments may be described. It should be appreciated that in the development of any such system, numerous implementation-specific decisions can be made to achieve specific goals, such as compliance with system-related and business-related constraints, which will vary from one implementation to another. Moreover, it should be appreciated that such decisions might be complex and time-consuming, but would nevertheless be a routine undertaking for those of ordinary skill in the art having the benefit of this disclosure.

In accordance with one embodiment, a method is provided for non-destructive examination of surface wrinkle depth in a composite structure, which can overcome many of the aforementioned shortcomings (and others) by using a device capable of measuring changes to electromagnetic properties of a carbon or lightning strike mesh covered composite surface. Wrinkles in carbon fiber or lightning strike mesh substrate underlying paint, resin, adhesive, or the like can be measured using a probe that produces eddy currents in the substrate material through electromagnetic induction. The changes in depth and width of these wrinkles can be characterized by a unique probe response.

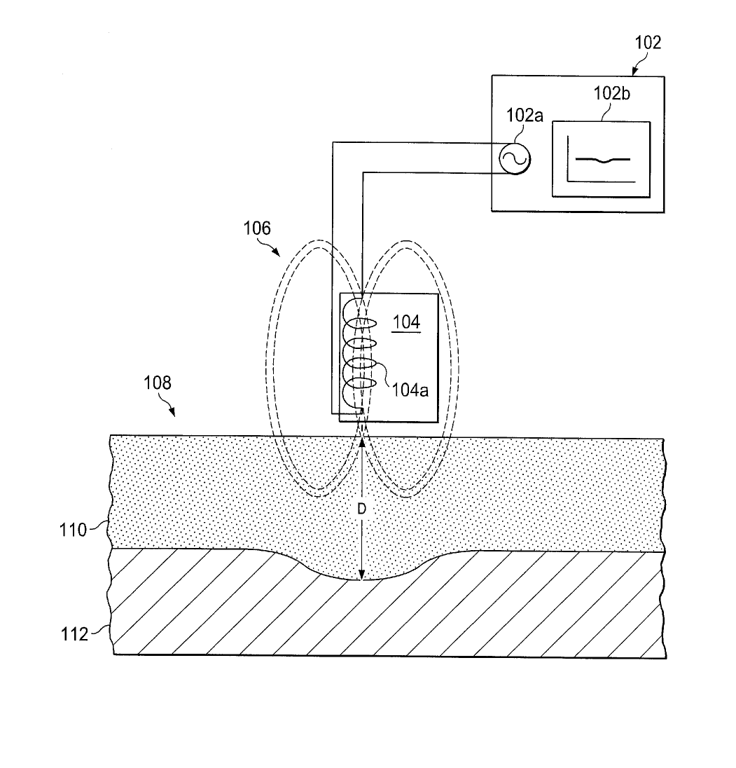

FIG. 1 is a simplified schematic diagram of an example embodiment of a system for determining wrinkle depth in a composite specimen. FIG. 1 includes a processing unit 102 coupled to a probe 104, which generally includes a coiled conductor 104a (such as copper wire). Processing unit may further provide an alternating current source 102a and a response display element 102b. Alternating current source 102a can introduce alternating current into probe 104, which produces a magnetic field 106 around probe 104.

Probe 104 may be placed adjacent to a specimen 108, such as a tail portion of an aircraft. Specimen 108 may further include a non-conductive surface coating 110, such as paint or resin, and a conductive substrate 112, such as carbon fiber or LSP mesh. Magnetic field 106 can create eddy currents in conductive substrate 112 by moving probe 104 in close proximity to conductive substrate 112. Eddy currents are electrical currents induced in conductors when a conductor is exposed to a changing magnetic field, which can be due to relative motion of the field source and conductor, or due to variations of the field with time. These circulating eddies of current create induced magnetic fields that oppose the change of the original magnetic field, causing repulsive or drag forces between the conductor and the magnet. The strength of the eddy currents is proportional to the strength of the applied magnetic field, the electrical conductivity of the conductor, and rate of change of the field to which the conductor is exposed.

Thus, imperfections and other characteristics of the conductive substrate, including sub-surface wrinkles, can be determined non-destructively by scanning probe 104 along non-conductive surface coating 110 and measuring changes in electrical properties of probe 104. For example, the depth D of a sub-surface wrinkle can be measured by scanning probe 104 along non-conductive surface coating 110 and measuring changes in resistance or inductive reactance to determine changes in distance between probe 104 and conductive substrate 112.

Processing unit 102 may convert the responses of probe 104 into a format suitable for an output device, such as response display element 102b. For example, in certain embodiments, the responses of probe 104 may be converted into a signal representative of a numerical value in a given distance scale, a differential value, or a graph of absolute or relative distances. In yet other embodiments, processing unit 102 may be calibrated to trigger an audible or visual alert signal if the measurement indicates a distance that exceeds a certain tolerance limit, for example.

The systems and methods described herein can provide significant advantages, some of which have already been mentioned. For example, such systems and methods can enable producers of composite airframe structures to accurately measure the depth and severity of surface wrinkling on exterior surfaces that contain carbon composite and use LSP systems. These measurements can be used to prove compliance with lightning strike requirements for non-conductive coating thickness over LSP mesh, or strength requirements related to reduction of strength due to fiber orientation deviation for fuselage and airframe structures, for example. Moreover, these systems and methods can use low-cost, portable equipment that is suitable for manufacturing and field environments, while providing quick and accurate measurements with little operator interpretation.

Certain example embodiments have been shown in the drawings and described above, but variations in these embodiments will be apparent to those skilled in the art. The principles disclosed herein are readily applicable to a variety of composite structures, including aircraft, spacecraft, and wind turbines, for example. The preceding description is for illustration purposes only, and the claims below should not be construed as limited to the specific embodiments shown and described.

1. A method for measuring sub-surface wrinkles in a specimen having a non-conductive surface and a conductive substrate, comprising:
applying an alternating current to a probe having a coil conductor;
scanning the probe across the non-conductive surface to induce eddy currents in the conductive substrate;
measuring changes in an electrical property of the probe in response to changes in the eddy currents indicative of variations in the depth of the conductive substrate;
converting the measurements to a format for display on an output device; and
displaying the measurements on the output device.

2. The method of claim 1, further comprising converting the changes in the electrical property to a signal suitable for an output device.

3. The method of claim 1, wherein the electrical property is resistance.

4. The method of claim 1, wherein the electrical property is inductive reactance.

5. The method of claim 1, wherein the conductive substrate is a lightning strike protection substrate.

6. The method of claim 1, wherein the conductive substrate is a carbon substrate.

7. The method of claim 1, wherein the coil conductor is a copper wire.

8. The method of claim 1, wherein the output device displays a signal representative of a numerical value in a given distance scale.

9. The method of claim 1, wherein the output device displays a signal representative of a differential value.

10. The method of claim 1, wherein the output device displays a signal representative of a graph of at least one of an absolute and a relative distance.
